(19) United States
(12) Patent Application Publication
(10) Pub. No.: US 2005/0173687 A1
(43) Pub. Date: Aug. 11, 2005

(54) Ratchet block

(76) Inventor: Giles Smith, Burnham-on-Crouch (GB)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/051,011

(22) Filed: Feb. 4, 2005

(30) Foreign Application Priority Data
Feb. 5, 2004 (GB) 04 02552.4

(51) Int. Cl. B66D 3/04

(52) U.S. Cl. 254/391

(57) ABSTRACT

A ratchet block has a sheave rotatably supported in a block body and a releasable ratchet mechanism which when engaged permits only unidirectional rotation of the sheave. A ring of ratchet teeth is provided on the sheave and a pawl is carried by the body for movement between a released position where the sheave may rotate freely and an engaged position where the pawl interacts with the teeth to permit only unidirectional rotation of the sheave. An operating member is carried by the body and is movable between free and active positions. A compression spring is arranged between the operating member and the pawl so as to be deformed by movement of the operating member, thereby biasing the pawl to be maintained stably at either its released or engaged position, depending upon the selected position of the operating member.

### BACKGROUND OF THE INVENTION

a) Field of the Invention

This invention relates to a ratchet block having a body which rotatably supports a sheave together with a unidirectional releasable ratchet mechanism for the sheave.

Though the ratchet block of this invention may be used in a variety of circumstances, it has a particular application in relation to racing dinghies. As such, it will be described exclusively with reference to that use, even though the invention is not to be regarded as limited thereto.

b) Description of the Prior Art

Pulley blocks are used extensively on the running rigging of racing dinghies, to assist in the hoisting and trimming of the sails. Such pulley blocks are required to have very low friction in order to minimise losses and also to have relatively low weights. A common form of block employed in connection with a sheet (rope) which must frequently be adjusted during sailing of the dinghy, such as a mainsheet used to adjust the mainsail or in conjunction with the jib sail or spinnaker sheets, has a ratchet mechanism which, when engaged, allows the sheave to rotate only in one direction. Such a block may be used to take much of the load off the sheet, by resisting movement of the sheet round the block in a sense which releases the sail, but which allows easy hardening of the sheet. Usually, the ratchet mechanism may be disengaged if required, though many dinghy sailors leave the ratchet mechanism engaged whenever sailing.

Various ratchet mechanisms have been designed for use in ratchet blocks, but such mechanisms add to the complexity of the block and so may also reduce the reliability of the block when the block is being used under extreme conditions. Further, the ratchet mechanism may inadvertently be released when the block is being subjected to a very large load, for example by accidental contact with the block, which may easily occur under racing conditions. Unexpected release of the ratchet mechanism when reliance is being placed on it remaining engaged to relieve the load of a rope passing round the sheave may have serious consequences and a possible capsize.

### BRIEF SUMMARY OF THE INVENTION

It is a principal aim of the present invention to provide a ratchet block incorporating a ratchet mechanism which is of simple construction and which need not greatly increase the overall weight of a block, as compared to a similar block having a sheave freely rotatable in either sense.

According to this invention, there is provided a ratchet block having a body rotatably supporting a sheave and a releasable ratchet mechanism which when engaged permits only unidirectional rotation of the sheave. The ratchet mechanism comprises a ring of ratchet teeth on the sheave, and a pawl carried by the body and movable between a released position where the sheave may rotate freely and an engaged position where the pawl interacts with said teeth to permit rotation of the sheave in only one direction. An operating member for the pawl is also carried by the body and movable between free and active positions. A spring interconnects the operating member and the pawl and is arranged such that the pawl is held stably by the spring at either its released position or its engaged position depending upon the selected position of the operating member.

### BRIEF DESCRIPTION OF THE DRAWINGS

The drawings show a specific embodiment of ratchet block constructed and arranged in accordance with this invention, though solely by way of example. In the drawings:

FIG. 1 is an isometric view of part of the embodiment of ratchet block, showing one body half rotatably supporting an annular sheave and incorporating a ratchet mechanism within the central region of the sheave; and

FIGS. 2 and 3 diagrammatically illustrate the operation of the ratchet mechanism, respectively in free and engaged positions.

### DETAILED DESCRIPTION OF THE INVENTION

The ratchet mechanism of a block of this invention is arranged so that movement of the operating member serves to deform the spring, to provide the stable released and engaged positions for the pawl. For such a case, the spring may be the sole interconnection between the operating member and the pawl, deformation of the spring on actuating the operating member serving to move the pawl between its said two positions.

A ratchet mechanism as used in a ratchet block of this invention may have only two moving parts—the pawl and the operating member—linked by a simple spring such as a helical compression spring. Both the pawl and the operating member may be arranged for rotation about axes parallel to the rotational axis of the sheave. Thus, it may be relatively easy to implement the ratchet mechanism on a known design of block, giving only a small increase in the overall weight of the block.

The pawl may be pivotally mounted on the body for rotational movement between its released and engaged positions. In a specific embodiment, the pawl is in the form of an arm pivoted at one end to the block body, the other end of the arm being appropriately profiled as a claw for engaging the ratchet teeth of the sheave, and when so engaged, permitting only unidirectional rotation of the sheave.

The operating member may be mounted on the body also for rotational movement between its free and active positions, spaced typically by about 90° of arc. Such an operating member may be provided with an aperture extending at least partway therethrough, transverse to the axis of rotation of the operating member, the spring comprising a helical coil spring acting in compression and having one end received in the aperture, the other end of the spring connecting to the pawl. The line of action of the spring on the pawl should be constrained to pass generally through the pivotal axis of the pawl, the operating member then bending the axis of the spring thereby to exert either a clockwise or a counter-clockwise turning moment on the pawl, depending upon the setting of the operating member.

The pawl could have an opening adjacent its pivotal connection to the body of the block and in which the end of the spring remote from the operating member is received. However, that would require the pawl to be of increased size in the region of its pivotal connection and so it is preferred for the pawl to have a projecting spigot adjacent its pivotal axis, the spigot being received within the coils of the helical spring whereby torque may be applied to the pawl.

It is preferred for there to be a detent mechanism securely to retain the operating member in its free or active position, as required. Conveniently, the aperture in the operating member extends wholly therethrough so that the detent mechanism may include a peg slidably received in the aperture, the spring acting on and urging the peg out of the aperture, in the direction away from the pawl. The detent mechanism further comprises a track on the body of the block, closely adjacent the operating member and along which the peg may slide, the track having a pair of spaced recesses into which the peg may be received respectively at the free and active positions of the operating member. The peg and recesses should be so profiled that a sufficient turning force applied to the operating member will move the peg out of the respective recess thereby permitting rotation of the operating member to its other position.

The ratchet block of this invention is particularly applicable to a block having an annular sheave, mounted between a pair of side cheeks forming the body of the block, the ratchet teeth being formed internally around the inner opening of the sheave. The ratchet mechanism may then be mounted within the annular sheave, such that the pawl may engage those teeth when driven to its engaged position by rotation of the operating member to its active position. For such a construction, the operating member may extend through the body of the pulley block and at least one end thereof should be provided with a manually-grippable projection whereby the operating member may be manually turned between its two positions, at will.

The embodiment of ratchet block of this invention shown in the drawings has a pair of moulded plastics body parts 10, only one of which is shown in the drawings. Each body part defines a side cheek 11 and includes half of a bridging member 12 such that when the two body parts are fitted together, the bridging member is completed and serves to hold the two side cheeks 11 parallel and spaced apart by a distance sufficient to accommodate an annular sheave 13 therebetween. The two body parts making up the block body may be identical, with each provided with two projecting spigots 14,15 offset from the centre line for the block part, there being correspondingly positioned bores 16,17 to receive the spigots of the other block part. A U-shaped metallic strap (not shown) has its two arms extending along a respective side cheek 11, from the bridging member 12 towards the opposed end of the body, the base of the strap lying externally over the bridging member and being accommodated in groove 18 therein. The assembly of the two body parts and the metallic strap is held together by means of two pegs (not shown) or similar retaining fasteners extending through aligned holes 19,20 in the two body parts, the strap extending at least as far as the hole 19 nearer the bridging member so as to be secured in position by the fastener extending through that hole. Those holes 19,20 lie within the internal opening of the annular sheave 13.

The sheave 13 is rotatably supported on the two side cheeks 11 by respective ball races to each side of the sheave and defined by an outer race 21 moulded integrally with the side cheek and an inner race 22 moulded integrally with the sheave, adjacent its inner opening. Around the internal periphery of the annular sheave, there is a ring of ratchet teeth 24 for interaction with a pawl 25 as will be described below.

The pawl 25 comprises an arm provided with a pawl claw 26 at one end and a bore at its other end, by means of which the pawl is pivotally mounted on the retaining fastener extending through hole 19 in the side cheeks 11. The pawl includes a spigot 27 projecting laterally from the other end of the arm, adjacent its pivotal connection to the side cheeks. A generally cylindrical operating member 28 is provided in a bore extending through the two side cheeks, on the axis of rotation of the sheave 13. That operating member 28 is provided with a central transverse aperture 29, a peg 30 being slidably mounted in that aperture. A helical coil spring 31 extends between the operating member 28 and the pawl 25, one end of the spring being located on the spigot 27 and the other end being received in the aperture 29, to engage the peg 30 and urge the peg away from the pawl.

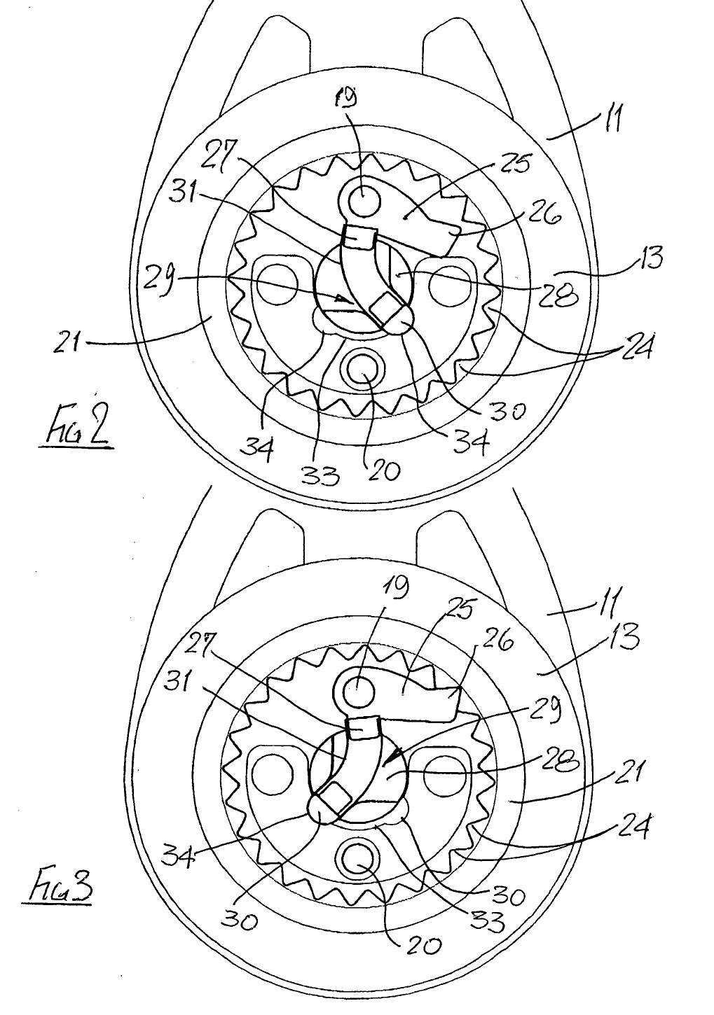

A track 33 is provided around the part of the operating member 28 remote from the pawl 25, that track having a pair of arcuately-spaced recesses 34 in which the peg 30 may be received. The peg 30, track 33 and recesses 34 thus act as a detent mechanism for the operating member 28, to define an active position (FIG. 2) and a free position (FIG. 3) respectively, corresponding to an engaged position and a released position, for the pawl 25. The end of the peg 30 remote from the operating member 28 is rounded and also the recesses are correspondingly rounded, so that a sufficient torque applied to the operating member will drive the peg further into the aperture in the operating member against the action of the spring, thus permitting the operating member to be moved away from one detent position towards the other detent position.

The ratchet mechanism operates as a kind of over-centre mechanism such that the spring 31 will apply a torque to the pawl 25, either in a counter-clockwise sense (FIG. 2) or in a clockwise sense (FIG. 3). Each of these positions for the pawl is a stable position such that the pawl will remain there until moved by the rotation of the operating member, to its other detent position.

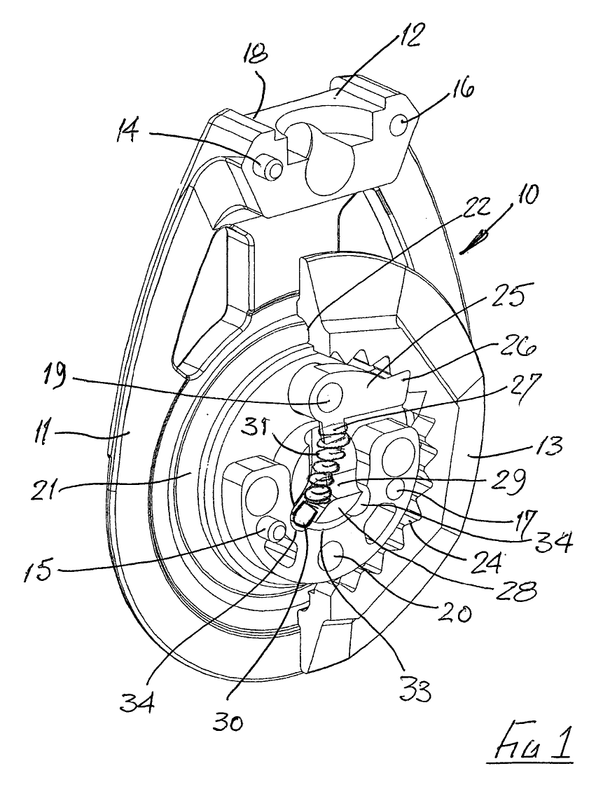

When the claw 26 of the pawl 25 is engaged with the ratchet teeth 24 of the sheave 13 (FIGS. 1 and 2), the sheave may rotate in a clockwise sense (FIG. 1) with the claw riding over the teeth of the sheave. If however a force is applied to the sheave tending to rotate the sheave in a counter-clockwise sense, the pawl will be urged deeper into engagement with the teeth and prevent rotation of the sheave. Further, whilst loaded in this way, even if the operating member is turned to the position of FIG. 3, the load applied to the pawl through the claw and teeth will maintain the pawl in its engaged position, such that the mechanism will continue to resist counter-clockwise rotation of the sheave. As soon as the load is removed from the block, the pawl will become free to move to its released position under the action of spring 31.

Though not shown in the drawings, the operating member 28 may have a projecting tab provided on each end face, externally of the respective cheek, which tab may be gripped between a thumb and finger in order to permit the operating member to be turned from one position to its other. The outer faces of the block cheeks may be recessed within the central region of the sheave, such that the tab may be located wholly within that recess and so not be vulnerable to damage or accidental rotation.

Conveniently, as well as the block parts 10, the sheave, pawl and operating member all may be moulded from a plastics material. This assists in maintaining a low overall weight for the block. Further, in view of the relatively few and simply moving parts for the ratchet mechanism, excellent reliability may be anticipated.

1. A ratchet block having a body, a sheave rotatably supported in the body, and a releasable ratchet mechanism which when engaged permits only unidirectional rotation of the sheave, said ratchet mechanism comprising a ring of ratchet teeth on the sheave, a pawl carried by the body and movable between a released position where the sheave may rotate freely and an engaged position where the pawl interacts with said teeth to permit rotation of the sheave in only one direction, an operating member also carried by the body and movable between free and active positions, and a spring interconnecting the operating member and the pawl and arranged such that the pawl is held stably by the spring at a selected one of its released and engaged positions, depending upon the selected position of the operating member.

2. A ratchet block as claimed claim 1, wherein movement of the operating member of the ratchet mechanism serves to deform the spring thereby providing stable released and engaged positions for the pawl.

3. A ratchet block as claimed in claim 1, wherein the pawl is pivotally mounted on the body, for rotational movement between its released and active positions.

4. A ratchet block as claimed in claim 3, wherein the pawl is in the form of an arm pivoted at one end to the block body and the other end of the arm being formed for engaging the teeth of the sheave.

5. A ratchet block as claimed in claim 1, wherein the operating member is mounted on the body for rotational movement between its free and active positions.

6. A ratchet block as claimed in claim 5, wherein the sheave and the operating member are mounted for rotation about a common axis on the block body.

7. A ratchet block as claimed in claim 1, wherein the spring comprises a helical coil spring acting in compression on the pawl.

8. A ratchet block as claimed in claim 7, wherein the line of action of the spring is constrained to pass generally through the rotational axis of the pawl, the operating member being arranged to bend the axis of the spring thereby to exert a clockwise or counter-clockwise turning moment on the pawl, depending upon the setting of the operating member.

9. A ratchet block as claimed in claim 8, wherein the pawl is provided with a projecting spigot adjacent the pivotal axis thereof, the helical spring being engaged with the spigot to apply torque to the pawl.

10. A ratchet block as claimed in claim 8, wherein the operating member has an opening extending transversely to its axis of rotation, the spring being received in said opening whereby movement of the operating member between its free and active positions changes the bend in the spring.

11. A ratchet block as claimed in claim 10, wherein there is provided a track adjacent the periphery of the operating member, the opening in the operating member extending through the operating member, and a peg is mounted in the opening to be urged by the spring into engagement with the track.

12. A ratchet block as claimed in claim 11, wherein the track has two detents disposed at locations corresponding to the free and active positions of the operating member, the peg being received in a respective detent to resist movement of the operating member away from the corresponding position.

13. A ratchet block as claimed in claim 1, wherein the sheave is in the form of an annulus having an inner periphery, said teeth being formed internally around said inner periphery.

14. A ratchet block as claimed in claim 13, wherein the block body defines a pair of spaced races and the sheave is provided with a pair of corresponding races, balls being provided between the opposed races on the body and sheave respectively whereby the sheave is rotatably supported on the body.

15. A ratchet block as claimed in claim 1, wherein the body comprises a pair of opposed cheeks between which the sheave is rotatably supported.

16. A ratchet block as claimed in claim 1, wherein the operating member extends through the body and at least one end thereof is provided with a manually-grippable projection whereby the operating member may be manually turned between its said two positions, at will.

17. A ratchet block having a body, a sheave rotatably supported in the body and a releasable ratchet mechanism which when engaged permits only unidirectional rotation of the sheave, said ratchet mechanism comprising a ring of ratchet teeth on the sheave, and a pawl carried by the body and movable between a released position where the sheave may rotate freely and an engaged position where the pawl interacts with said teeth to permit rotation of the sheave in only one direction, wherein said pawl is in the form of an arm pivotally mounted at one end on the block body and the other end of the arm being formed for engaging the teeth of the sheave, said ratchet mechanism further comprising an operating member pivoted to the body and movable between free and active positions, and a helical coil spring acting in compression between the operating member and the pawl and arranged such that the pawl is held stably by the spring at a selected one of its released and engaged positions, depending upon the selected position of the operating member, whereby the operating member is arranged to bend the axis of the spring thereby to exert a clockwise or counter-clockwise turning moment on the pawl, depending upon the setting of the operating member.

18. A ratchet block as claimed in claim 17, wherein the pawl is provided with a projecting spigot adjacent the pivotal axis thereof, said helical coil spring being engaged with the spigot to apply torque to the pawl.

19. A ratchet block as claimed in claim 17, wherein the operating member has an opening extending transversely to its axis of rotation, the spring being received in said opening whereby movement of the operating member between its free and active positions changes the bend in the spring.

20. A ratchet block as claimed in claim 17, wherein the block body defines a pair of spaced races and the sheave is provided with a pair of corresponding races, balls being provided between the opposed races on the body and sheave respectively whereby the sheave is rotatably supported on the body.
